(19) United States
(12) Patent Application Publication
(10) Pub. No.: US 2024/0119281 A1
(43) Pub. Date: Apr. 11, 2024

(54) AI BASED TECHNIQUES FOR PHOTOVOLTAIC INTERRUPTION CONTROL IN MICROGRIDS WITH ENERGY STORAGE SYSTEMS

(71) Applicant: KING FAHD UNIVERSITY OF PETROLEUM AND MINERALS, Dhahran (SA)

(72) Inventors: Muhammad KHALID, Dhahran (SA); Miswar Akhtar SYED, Dhahran (SA)

(73) Assignee: KING FAHD UNIVERSITY OF PETROLEUM AND MINERALS, Dhahran (SA)

(21) Appl. No.: 18/306,745

(22) Filed: Apr. 25, 2023

Related U.S. Application Data
(60) Provisional application No. 63/411,661, filed on Sep. 30, 2022.

(51) Int. Cl. G06N 3/08; G05B 19/042; G06N 5/022; H02J 3/28; H02J 3/38

(52) U.S. Cl. CPC G06N 3/08; G05B 19/042; G06N 5/022; H02J 3/28; H02J 3/381; G05B 2219/2639; H02J 2300/26; H02J 2300/28

(57) ABSTRACT

An intermittent power system to provide smoothed electric power into a power grid that includes an intermittent power source, a neural network-based predictive controller (NNPC) and a low pass filter (LPF) connected to the power grid to provide the smoothed electric power. The LPF provides a smoothed power reference for the NNPC. The system further includes a neural network predictor connected between the intermittent power source and the NNPC, and a power grid connection. The neural network predictor takes electric power from the intermittent power source as an input and makes a prediction of unsmoothed electric power. A power grid connection provides the smoothed electric power of the NNPC into the power grid. The NN model solves issues related to the mathematical complexity of a conventional MPC model that arises due to the increasing complications in an intermittent power plant, including a PV power plant.

### CROSS-REFERENCE TO RELATED APPLICATIONS

This application claims the benefit of priority to provisional application No. 63/411,661 filed Sep. 30, 2022, the entire contents of which are incorporated herein by reference.

### STATEMENT REGARDING PRIOR DISCLOSURE BY THE INVENTORS

Aspects of this technology are described in an article “Neural network predictive control for smoothing of solar power fluctuations with battery energy storage,” Journal of Energy Storage (2021). The article was published October 2021, and is herein incorporated by reference in its entirety.

### STATEMENT OF ACKNOWLEDGEMENT

The authors would like to acknowledge the support provided by the Deanship of Scientific Research (DSR) at King Fand University of Petroleum and Minerals (KFUPM), Saudi Arabia for funding this work through the project No. DF201011. Also, the authors would like to acknowledge the financial support provided by the King Abdullah City for Atomic and Renewable Energy, Saudi Arabia (K.A. CARE).

### TECHNICAL FIELD

### Background

The present disclosure is directed to smoothing of electric power fluctuations in a plant, and particularly, to an artificial intelligence (AI) based system for providing smoothed electric power into a power grid.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Renewable energy is one of the fastestgrowing energy technologies, and in particular, solar energy is preferred as it helps to generate power cost effectively and with zero carbon emissions. However, the inherent intermittent nature of solar power due to variations in the sunlight, e.g., caused by moving clouds, makes it a challenge to dispatch uninterrupted power into grid. The resultant fluctuating power can cause various problems in the grid such as frequency deviations, voltage hindrances, and excessive peak loads which ultimately would lead to electricity blackouts or power outages in the grids. Therefore, to encourage the delivery of large-scale solar power into the grid, solar photovoltaic (PV) power output needs to be smoothed out before it can be dispatched into the grid in a controlled manner. An energy storage system (ESS) can be integrated with the renewable energy (RE) resources for power supply regulation, management, and optimal operation. In particular, a battery energy storage system (BESS) can be integrated with the RE systems to produce promising results. The BESS can be integrated with the solar PV to mitigate the issue of the fluctuating solar power. Improving the lifespan of the BESS while lessening the operating expenses is a well-investigated area Studies have recommended innovative supervision procedures for improving the lifetime of the BESS while determining the battery charging/discharging power.

Several control systems have been combined with the BESS to strengthen the comprehensive competence of the dispatched power and to reduce the cost of the system. Model predictive control (MPC) is a commonly used efficient control management method that simplifies convoluted optimization problems at individual time instants into limited closed-loop optimization problems, while simultaneously controlling the enforced constraints. Similar to the MPC centered approach, an optimum response control merged with a genetic algorithm has been suggested to lessen the output power variations. Moreover, a study in [See: J. Mattingley, Y. Wang, S. Boyd, Receding horizon control, IEEE Control Syst. Mag. 31 (3) (2011) 52-65] proposes the accumulation of fast fourier transform with the ESS for solar power smoothing. Alongside the formerly stated control methods, fuzzy logic control and washout filter-based control have been initiated for hybrid wind/PV power leveling. Solar vigorous power curtailing is employed in [See: W. Ma, W. Wang, X. Wu, R. Hu, F. Tang, W. Zhang, X. Han, L. Ding, Optimal allocation of hybrid energy storage systems for smoothing photovoltaic power fluctuations considering the active power curtailment of photovoltaic, IEEE Access 7 (2019) 74787-74799] with an optimal hybrid ESS distribution model to smooth the power alternations. Additionally, to strengthen the use of ESS and to diminish the energy obtained from the main grid, PV power smoothing is completed [See: D.-I. Stroe, A. Zaharof F. Iov, Power and energy management with battery storage for a hybrid residential PV-wind system-a case study for Denmark, Energy Procedia 155 (2018) 464-477, incorporated herein by reference in its entirety] by an energy block method. One study [See: M. A. Mohamed, A. A. Z. Diab, H. Rezk, Partial shading mitigation of PV systems via different meta-heuristic techniques, Renew. Energy 130 (2019) 1159-1175] proposed numerous meta-exploratory optimization algorithms such as gray wolf optimization (GWO), global maximum power point (GMPP), moth-flame optimization (MFO), hybrid particle swarm optimization gravitational search algorithm (PSO-GSA), and salp swarm algorithm (SSA) for maximum power point tracking and improving the PV scheme efficacy under fractional shading circumstances. However, the known systems and studies lack a control system that can efficiently reduce the PV variabilities while optimizing the battery state of charge and reducing the ramp rate under practical constraints.

Accordingly, it is one object of the present disclosure to provide a system that utilizes a neural network model for effective PV smoothing and battery energy storage management and for providing smoothed electric power into the grid. Further, it is an object of the present disclosure to provide a neural network-based predictive controller (NNPC) system that combines the concept of MPC with neural networks (NNs) coupled with a battery energy storage system (BESS) for smoothing of solar PV fluctuations.

### SUMMARY

In an exemplary embodiment, an intermittent power system to provide smoothed electric power into a power grid is described. The intermittent power system includes an intermittent power source, a neural network-based predictive controller (NNPC) and a low pass filter (LPF) connected to the power grid to provide the smoothed electric power. The LPF provides a reference for the NNPC. The intermittent power system further includes a neural network predictor connected between the intermittent power source and the NNPC and a power grid connection. The neural network predictor takes electric power from the intermittent power source as an input and makes a prediction of unsmoothed electric power.

In some embodiments, the system further includes a battery energy storage system (BESS) connected to the NNPC. The electric power to the power grid is a combination of battery power and smoothed electric power.

In some embodiments, the NNPC maintains optimal storage capacity of the battery energy storage system while achieving the objective of smoothing the electric power subject to power fluctuations.

In some embodiments, the NNPC includes an optimization algorithm and a neural network model. The optimization algorithm determines a control signal that minimizes LPF time constant based on an output from the neural network model while keeping battery State of Charge (SoC) within predetermined limits and the neural network model is trained on a model of an intermittent power plant to predict future smoothing performance.

In some embodiments, the neural network predictor is a feed forward network having a hidden layer and an input that includes solar irradiance from integrated radiation sensor, hours of a sensor box, ambient temperature, and module temperature, and predicts future unsmoothed power.

In some embodiments, the intermittent power system is a solar photovoltaic (PV) system, and the intermittent power source is a photovoltaic (PV) power source.

In some embodiments, the intermittent power system is a wind power system, and the intermittent power source is a wind turbine.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic block diagram of an intermittent power system for providing smoothed electric power to a power grid, according to certain embodiments;

FIG. 2 illustrates a prediction and control system model of the intermittent power system, according to certain embodiments;

FIG. 3 is a representation of a single neuron having an input and an output, according to certain embodiments;

FIG. 4 is an exemplary two-layer feed forward neural network for photovoltaic (PV) power prediction, according to certain embodiments;

FIG. 5 is a schematic block diagram of a neural network-based predictive controller (NNPC) of the intermittent power system, according to certain embodiments;

FIG. 6 is a graphical representation of recorded PV data corresponding to solar power, according to certain embodiments;

FIG. 7 is a graphical representation of solar irradiance data received from an integrated radiation sensor, according to certain embodiments;

FIG. 8 is a graphical representation of sensor box hours, according to certain embodiments;

FIG. 9 is a graphical representation of ambient temperature, according to certain embodiments;

FIG. 10 is a graphical representation of PV module temperature, according to certain embodiments;

FIG. 11 is a graphical representation of a comparison of an actual solar power with a predicted solar power, according to certain embodiments;

FIG. 12 illustrates a performance plot of a neural network (NN) during a training phase and a testing phase, according to certain embodiments;

FIG. 13 illustrates an error histogram plot of the NN with 20 bins, according to certain embodiments;

FIG. 14 illustrates a regression plot of the NN, according to certain embodiments;

FIG. 15 is a graphical representation of fluctuating solar power and smoothed solar power, according to certain embodiments;

FIG. 16 is a graphical representation of time delay-based comparison between the NNPC and low pass filter (LPF), according to certain embodiments;

FIG. 17 is a graphical representation of an effect of the NNPC and the LPF on battery state of charge (SoC), according to certain embodiments;

FIG. 18 is a graphical representation of an effect of the NNPC and the LPF on battery charging/discharging power, according to certain embodiments;

FIG. 19 is a graphical representation of the battery SoC fuzzy membership functions, according to certain embodiments;

FIG. 20 is a graphical representation of the LPF time constant (T_{ƒ}) fuzzy membership functions, according to certain embodiments;

FIG. 21 is a graphical representation of effect of the NNPC and a fuzzy logic controller (FLC) on the battery SoC, according to certain embodiments;

FIG. 22 is a graphical representation of effect of the NNPC and the FLC on the battery charging/discharging power, according to certain embodiments;

FIG. 23 is a graphical representation of solar power ramp rate with the NNPC and without the NNPC control, according to certain embodiments;

FIG. 24 is an exemplary schematic diagram of a computer system for implementing machine learning training and inference methods of the intermittent power system, according to certain embodiments;

FIG. 25 is an illustration of a non-limiting example of details of computing hardware used in the intermittent power system, according to certain embodiments;

FIG. 26 is an exemplary schematic diagram of a data processing system used within the intermittent power system, according to certain embodiments;

FIG. 27 is an exemplary schematic diagram of a processor used with the intermittent power system, according to certain embodiments; and

FIG. 28 is an illustration of a non-limiting example of distributed components which may share processing with the intermittent power system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to an intermittent power system for providing smoothed electric power to a power grid. Particularly, a neural network predictive control for smoothing of power fluctuations in a microgrid that includes renewable energy sources and various loads either individually or as a whole as a single system. The microgrid includes plant elements such as a battery energy storage and low pass filters. The control system preferably utilizes two neural networks, one for power prediction and the other for modeling a plant, in particular, power generation plants that use renewable energy such as solar energy and wind energy to generate electric power. The neural network (NN) model of the plant is for a predictive optimization step of a model predictive controller (NMPC). The NNPC is for photovoltaic (PV) power smoothing with a battery energy storage system (BESS). The NNPC is capable of firming and/or smoothing the solar power generated by a solar power source such as one or more PV panels by employing inputs from a neural network (NN) model. The NNPC is also configured to optimize a battery's state of charge (SoC) under various practical constraints and consequently promote enhanced battery life. The intermittent power system includes a low pass filter (LPF) connected to a power grid along with the NNPC for providing the electric power and providing a reference for the NNPC. A neural network predictor is connected between an intermittent power source, such as a photovoltaic (PV) power source, and the NNPC to take PV power from the PV power source and make a prediction of unsmoothed PV power.

The invention utilizes a neural network model of the plant instead of a mathematical model. Unlike a mathematical model, a NN better encapsulates the dynamics of the plant and provides higher accuracy predictions. Furthermore, the precision of the NN plant model is further increased as the collected input-output plant data increases. The NN model also solves issues related to the mathematical complexity of the MPC model that arises due to the increasing complications in the plant. The NN allows modeling of highly complex plants with a relatively simpler approach.

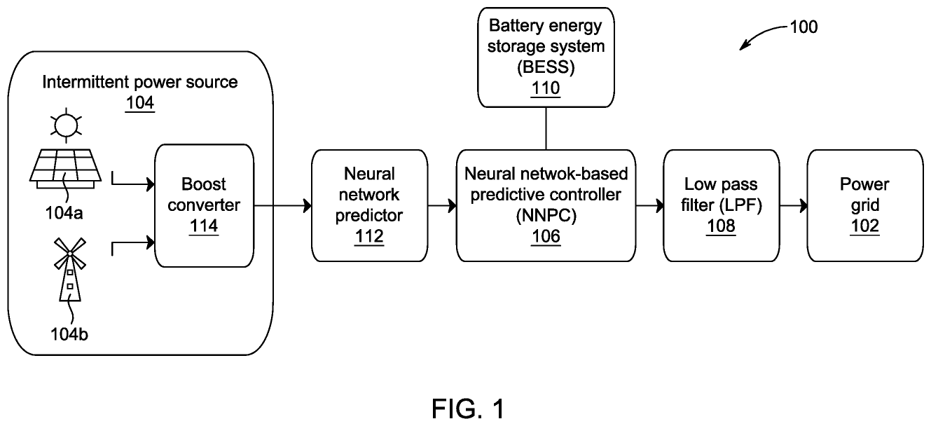

FIG. 1 illustrates a schematic block diagram of an intermittent power system 100 to provide smoothed electric power into a grid (a power grid, a utility grid or a microgrid), according to an embodiment of the present disclosure. The intermittent power system 100 (hereinafter referred to as system 100) is implemented in power generation plants that use renewable energy such as solar energy and wind energy to generate electric power.

Due to the large-scale penetration of intermittent PV power modules, multiple variations occur in the power grid, such as frequency issues and voltage deviations. To counteract such issues, a battery energy storage system (BESS) is integrated into the power grid, as the BESS reduces PV fluctuations and promotes optimal operation. However, the inherent intermittent nature of solar power or wind power makes it a challenge to deliver uninterrupted power to the power grid. To alleviate the problems associated with power outages, the system 100 is used to smooth fluctuations in a solar power plant or a wind power plant. The smoothing of the fluctuating power not only helps to dispatch power that complies with the grid standard but also maximizes the total benefits of the PV power as it becomes more controllable.

Referring to FIG. 1, the system 100 includes a power grid 102, an intermittent power source 104, a neural network-based predictive controller (NNPC) 106, a low pass filter (LPF) 108, a battery energy storage system (BESS) 110, a neural network (NN) predictor 112, and a boost converter 114.

In an embodiment, the power grid 102 is a commercial electric power distribution system. The power grid 102 is configured to receive generated electric energy (electricity) from the intermittent power source 104, and the BESS 110, and is further configured to transmit the received electricity over a certain distance via transmission lines. Further, the power grid 102 is configured to distribute the electricity to the consumer through a distribution system. End points of the power grid 102 are consumer locations when electricity is used to turn on various equipment such as the lights, television, dishwasher or such equipment's (acting as a load for the power grid 102).

The intermittent power source 104 is configured to generate electricity and is further configured to feed the generated electricity into the power grid 102 for distribution. The intermittent power source 104 may be the solar power plant, a wind power plant, a small hydro-power plant, a biomass-power plant, any renewable electricity generation unit, or a combination thereof. In one implementation of the present disclosure, the intermittent power source 104 may be a photovoltaic (PV) power source 104a, in such a case, the intermittent power system 100 may be a solar photovoltaic (PV) system. In particular, the intermittent power source 104 may include an array of solar panels to generate the electric power (solar PV power) based on sunlight received by photovoltaic (PV) solar cells of the solar panel. In an aspect, the solar power plant 104a includes a plurality of PV modules and a DC/DC voltage stabilizing module, such that the solar energy is converted into electric energy and transmitted to a direct current bus using the DC/DC voltage stabilizing module. In another implementation of the present disclosure, the intermittent power source 104 may be a wind turbine (wind power plant) 104b, in such a case, the intermittent power system 100 may be a wind power system. In an aspect, the wind power plant 104b is configured to convert the wind energy into electric energy. The wind power plant 104b includes a synchronous generator, an AD/DC rectifier and a DC/DC voltage stabilizing module which are sequentially connected to convert the wind energy into the electric energy. The wind turbine includes rotor blades to generate the electric power with the help of a drive train system and a generator based on wind energy. According to the present disclosure, the solar PV system is discussed in detail for the purpose of illustration of the present disclosure without limiting the scope of the invention, as such, the solar PV system is shown in FIG. 1. Hereinafter, the intermittent power system 100 is alternatively referred to as ‘the solar PV system 100’ or ‘the system 100’ and the intermittent power source 104 is alternatively referred to as ‘the PV power source 104’ or ‘the power source 104’.

In some embodiments, the intermittent power source 104 is configured to employ a maximum power point tracking (MPPT) algorithm to make the most of the PV array's output power, regardless to the radiation and temperature situations. For example, the MPPT algorithm is configured to continuously adjust an impedance of the PV array to keep the PV array operating at, or close to, the peak power point of the PV array under varying conditions, like changing solar irradiance, temperature, and load. The MPPT algorithm controls the voltage to ensure that the system operates at “maximum power point” (or peak voltage) on a power voltage curve. In some embodiments, the intermittent power source 104 may include the boost converter 114 and the MPPT to transfer maximum power from the solar PV module to the connected load (power grid 102).

The boost converter 114 is configured to boost the power produced by the intermittent power source 104 (solar power plant 104a, wind power plant 104b). In an aspect, the boost converter 114 (for example, step-up converter) is a DC-to-DC power converter that steps up voltage (while stepping down current) from its input (supply) to its output (load). In an example, the boost converter 114 may be an interleaved boost converter, which may improve the power processing capability and to operate the system 100 with its maximum power.

The NN predictor 112 is connected between the intermittent power source 104 (the PV power source 104), and the NNPC 106. The NN predictor 112 is configured to receive the solar PV power from the PV power source 104 as an input and to generate a prediction of unsmoothed PV power. In an aspect, the NN predictor 112 is coupled to the boost converter 114 to receive actual solar power as the input. The NN predictor 112 is configured to employ a digital moving average (MA) smoothing filter. The MA average smoothing filter receives the predicted photovoltaic (PV) power from the NN predictor 112 and to generates a reference for the NNPC 106. In an aspect, the NN predictor 112 is configured to predict a future unsmoothed power, which the MA filter can use to provide the smoothed PV power reference for the NNPC 106.

The NNPC 106 is coupled to the BESS 110, the NN predictor 112 and the LPF 108. The NNPC 106 is coupled to the power grid 102 to provide the electric power (smoothed PV power) via the LPF 108. In an aspect, the LPF 108 is also configured to provide a PV power reference for the NNPC 106. In some embodiments, the LPF 108 may be integrated along with the BESS 110 for optimal functioning and cost reduction. The BESS 110 includes rechargeable batteries that store electrical energy received from the intermittent power source 104 and provides a battery power when needed. In an example, the rechargeable batteries can also receive electrical energy from various other sources, such as diesel generators. For example, the BESS 110 includes several primary components, including one or more rechargeable batteries, monitoring and control systems, and a power conversion system. In an aspect, the BESS 110 may include a lead-acid battery, a redox flow battery, a sodium-sulfur battery, a lithium-ion battery, an ultracapacitor, etc.

In an aspect, the NNPC 106 includes a neural network (NN) model and an optimization algorithm. The NNPC 106 is configured to follow a predictive optimization step. The NNPC 106 is configured to receive the smoothed references from the NN predictor 112 and the LPF 108, respectively. The NN model is configured to reduce errors between an output and the reference signal received from the NN predictor 112. The NN model is configured to predict a future smoothed power over a specified time horizon. The optimization algorithm is configured to minimize a cost function and determine a control signal for controlling the time constant of the LPF 108. Having the units of time, the time constant represents the time for the exponential term to drop to 1/e or 36.79% of its original value. Each subsequent time constant will decrease it by the same fraction. Specifically, for a first-order filter, the time-constant is defined (approximately) as: t=½*PI*fc, where fc is the cutoff frequency. The optimization algorithm generates the control signal that minimizes the time constant of the LPF 108 based on the output from the NN model while keeping the battery's State of Charge (SoC) within predetermined limits. The time constant of the LPF 108 directly impacts the degree of PV power smoothing. Using the control signal, the NNPC 106 regulates the value of the time constant of the LPF 108 so that the LPF 108 can efficiently reduce the PV fluctuations. In an overall implementation, the NNPC 106 is configured to employ a neural network based control system for controlling the time constant of the LPF 108 and to efficiently remove the fluctuations from the PV power (smoothed PV power) while operating under practical constraints.

With the integrated system of the NNPC 106 and the BESS 110, the electric power delivered to the power grid 102 is a combination of the battery power and smoothed PV power. Further, the NNPC 106 maintains an optimal storage capacity of the BESS 110, while achieving the objective of smoothing the electric power subject to solar PV power fluctuations.

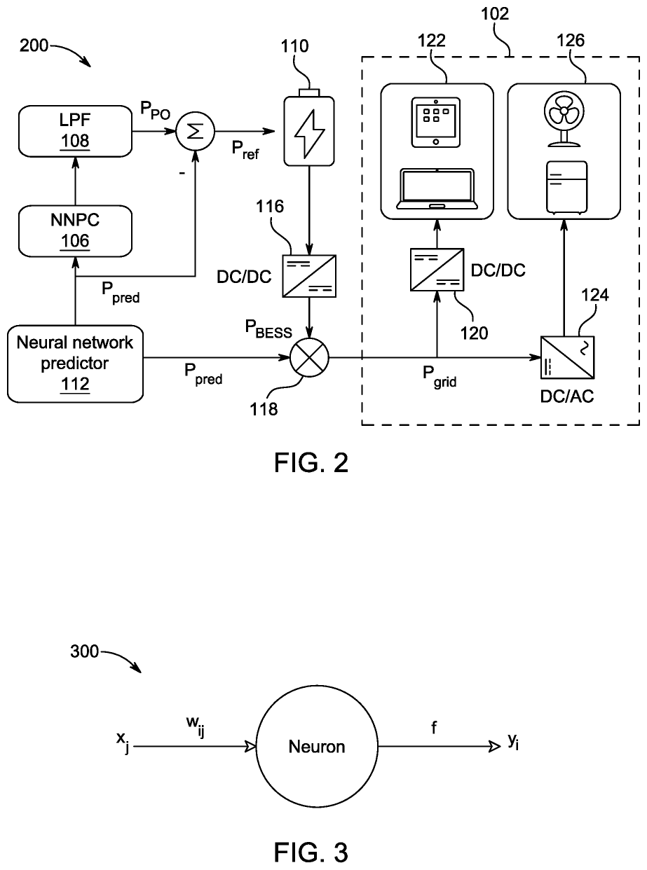

FIG. 2 illustrates a prediction and control system model 200 of the system 100, according to certain embodiments. In an aspect, the prediction and control system model (also known as plant model) 200 is for solar PV power smoothing. As an example of a type of smoothing, ramp-rate control smoothing methods are described in: S. Sukumar, M. Marsadek, K. Agileswari, H. Mokhlis, Ramp-rate control smoothing methods to control output power fluctuations from solar photovoltaic (PV) sources-A review, J. Energy Storage 20 (2018) 218-229; A. Desta, P. Courbin, V. Sciandra, L. George, Gaussian-Based smoothing of wind and solar power productions using batteries, Int. J. Mech. Eng. Robotics Res. 6 (2) (2017) 154-159, incorporated herein by reference in its entirety.

The NN predictor 112 is configured to provide the predicted unsmoothed power, denoted by P_{pred}, to the NNPC 106. The LPF 108 is configured to generate the smoothed power, denoted by P_{PO}. Charging and discharging power P_{ref} of the BESS 110 is the difference between the smoothed power P_{PO} and the predicted unsmoothed power P_{pred}. The BESS 110 is configured to output the battery power denoted by P_{BESS}. The BESS 110 is connected with a Direct Current (DC)-DC converter 116 that converts the DC voltage received from the BESS 110, from one voltage level to another voltage level. The electric power (P_{grid}) fed to the power grid 102 is a combination of the battery power P_{BESS} and the predicted unsmoothed power P_{pred}, as shown by 118 in FIG. 2.

As shown in FIG. 2, the power grid 102 includes a plurality of DC loads 122, and a plurality of AC loads 126. The DC-DC converter 120 converts the DC voltage received from the power grid 102, from one voltage level to another level and feeds the DC voltage to the plurality of DC loads 122. The AC-DC converter 124 is configured to convert an alternating current (AC) into the DC. The AC-DC converter 124 provides an AC output to the plurality of AC loads 126.

The BESS 110 is configured to charge when the battery power P_{BESS} is positive and to discharge when the battery power P_{BESS} is negative. The value of the time constant T_{ƒ} of the LPF 108 determines the output power smoothness, time delay, battery charging/discharging, and the state of charge (SoC) [See: A. A. Abdalla, M. Khalid, Smoothing methodologies for photovoltaic power fluctuations, in: 2019 8th International Conference on Renewable Energy Research and Applications (ICRERA), IEEE, 2019, pp. 342-346; A. Atif, M. Khalid, Fuzzy logic controller for solar power smoothing based on controlled battery energy storage and varying low pass filter, IET Renew. Power Gener. 14 (18) (2020) 3824-3833; M. A. Syed, A. A. Abdalla, A. Al-Hamdi, M. Khalid, Double moving average methodology for smoothing of solar power fluctuations with battery energy storage, in: 2020 International Conference on Smart Grids and Energy Systems (SGES), IEEE, 2020, pp. 291-296, each incorporated herein by reference in their entirety]. Hence, the NNPC 106 is configured to regulate the value of the time constant T_{ƒ} such that the NNPC 106 generates a firmed PV power with minimum time delay, decreased battery charging/discharging power, and appropriate SoC management. The LPF 108 is based on a transfer function as given in equation (1), where the time constant T_{ƒ}=RC.

$$l H ( s ) = \frac{1}{{T}_{f} s + 1} . \qquad ( 1 )$$

The LPF generates the P_{ref} after performing the filtering given as follows:

$${P}_{ref} ( s ) = \frac{- s {T}_{f}}{{T}_{f} s + 1} \cdot {P}_{p r e d} ( s ) . \qquad ( 2 )$$

The battery SoC is given in equation (3), where E_{BESS} denotes a battery capacity of the BESS 110.

$$S o C ( s ) = \frac{- {P}_{BESS} ( s )}{s \cdot {E}_{BESS}} . \qquad ( 3 )$$

The battery thermal limitations depend on the battery capacity E_{BESS}. Higher capacity of the BESS means that the PV power can be handled without violating an upper battery thermal limitation and a lower battery thermal limitation. Equation (4) defines the battery capacity with respect to the battery SoC and the smoothed power P_{PO}.

$${E}_{B E S S} = \frac{{T}_{f} \cdot {P}_{P O} ( s )}{S o C ( s )} . \qquad ( 4 )$$

The battery capacity is a product of the LPF time constant T_{ƒ} with an average predicted PV power P̅_{pred} [A. A. Abdalla, M. Khalid, Smoothing methodologies for photovoltaic power fluctuations, in 2019 8th International Conference on Renewable Energy Research and Applications (ICRERA), IEEE, 2019, pp. 342-346, incorporated herein by reference in its entirety]. When the battery capacity (product T_{ƒ} *P̅_{pred}) is greater than the battery capacity E_{BESS} i.e., T_{ƒ} *P̅_{pred}≥E_{BESS}, the battery will overcharge as the battery SoC may exceed the maximum SoC limit of 100%. To overcome the issue of battery overcharging, a zoom coefficient K is introduced (as shown in equation (5)). The battery capacity is limited by setting a value for K such that 0≤K≤1. The average predicted unsmoothed PV power is denoted by P̅_{pred}.

KT_{ƒ}·P̅_{pred}≤E_{BESS}. (5)

The coefficient K is determined and defined based on an upper battery SoC limit and a lower battery SoC limit denoted by SoCₘₕ and SoCₘₗ, respectively, (as shown in equation (6)). A marginal capacity is removed from the used battery capacity given as E_{BESS}−(KT_{ƒ}*P_{pred}).

(SoCₘₕ+SoCₘₗ)·E_{BESS}=E_{BESS}−(KT_{ƒ}·P̅_{pred}). (6)

A battery SoC feedback control is applied with the system 100 to regulate the BESS 110 as shown in equation (7). Thus the battery output is the summation of charging/discharging power, storage capacity margins, and the smoothed PV power.

$${P}_{BESS}^{′} \cdot {T}_{f} = ( S o C ( s ) \cdot {E}_{B E S S} - ( \frac{K {T}_{f}}{{T}_{f} s + 1} \cdot {P}_{p r e d} ( s ) ) - ( {E}_{B E S S} - K {T}_{f} \cdot {\overline{P}}_{pred} ( s ) ) ) . \qquad ( 7 )$$

The dispatchable grid power is provided by equation (8), which is the summation of the PV power P_{pred} and P_{BESS}.

P_{grid}(s)=P_{BESS}+P_{pred}(s). (8)

According to the present disclosure, the neural network prediction system (the NN predictor 112) predicts the future unsmoothed power, such that the unsmoothed power is used by the digital MA filter to provide the smoothed PV power reference signal for the NNPC 106. The MA filter refers to a smoothing filter that is used for smoothing the signal generated from short term overshoots or noisy fluctuations. The MA filter helps retain a true signal representation or sharp step response. In some examples, the MA filter may be a simple moving average filter, a cumulative moving average filter, a weighted moving average filter, and an exponential moving average filter.

In an aspect, the NN predictor 112 utilizes previous data (historical data) to learn and recognize relationships between an input variable and an output variable, as shown in FIG. 3. FIG. 3 is a representation 300 of a single neuron according to certain embodiments. Referring to an exemplary single neuron of the NN model (as shown in FIG. 3), the neuron has an input xⱼ, a hidden layer, and an output yᵢ. For training the neuron, the input xⱼ is multiplied by a weight wᵢⱼ to obtain the product xⱼwᵢⱼ. The transfer function ƒ uses the product as an argument to yield the output yᵢ as shown in equation (9) represented as:

yᵢ=ƒ(Σⱼ₌₁ⁿxⱼwᵢⱼ), (9)

where i and j represent a neuron index of the hidden layer and the neural network inputs, respectively. Also, constants known as biases b are also added to the output yᵢ to ensure neuron activation in case of zero input value, as shown in equation (10).

The neuron output with bias b may be expressed as:

yᵢ=ƒ(Σⱼ₌₁ⁿxⱼwᵢⱼ)+b. (9)

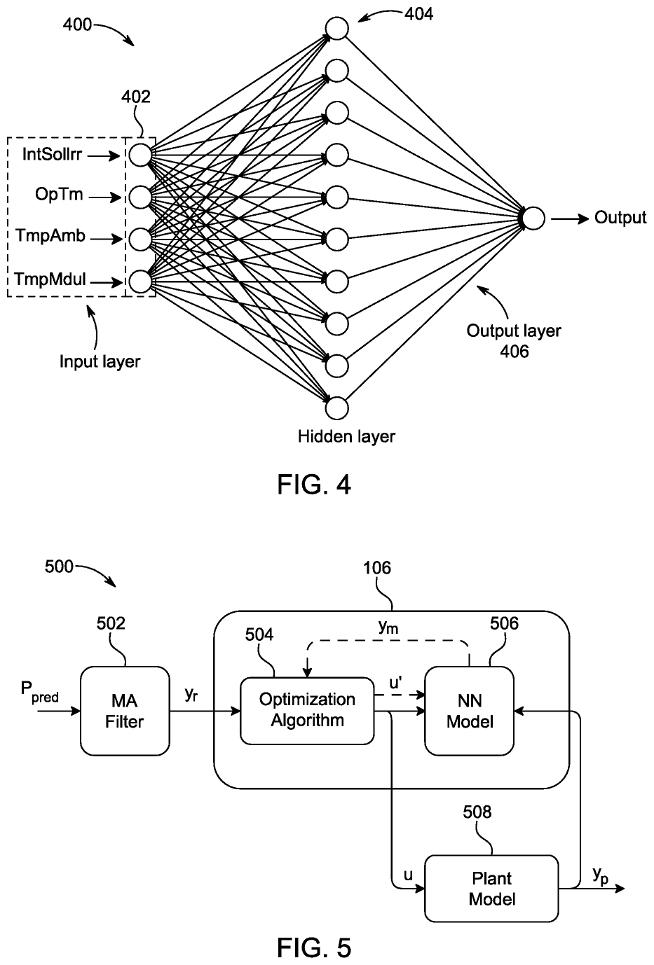

FIG. 4 is an exemplary two-layer feed forward neural network 400 for PV power prediction, according to certain embodiments. In the present disclosure, the NN predictor 112 employs the two-layer feed forward network 400 for predicting future unsmoothed power. As shown in FIG. 4, the feed forward neural network (deep feedforward network or multi-layer perceptron) 400 includes an input layer 402, a plurality of hidden layers 404, and an output layer 406. A number of the plurality of hidden layers 404 can be adjusted based on the desired output performance. According to the present disclosure, the NN predictor 112 includes 10 hidden layers for increased accuracy. The input layer 402 includes four inputs such as a solar irradiance, hours of a sensor box, an ambient temperature, and a module temperature. The solar irradiance refers to the power per unit area received by the solar panels from the sun in the form of electromagnetic radiation. The solar irradiance may be detected by a solar radiation sensor, an integrated radiation sensor, or a pyranometer. In an example, the solar radiation sensor is mounted on the solar panel. In some examples, the solar radiation sensor may be integrated with the solar panel to detect the solar irradiance. The ambient temperature refers to a temperature of air surrounding the solar panel, and the module temperature refers to a temperature of surface of the solar panel. The ambient temperature may be detected by an ambient air temperature sensor that is disposed in the proximity of the solar panel. The module temperature may be detected by a PV module temperature sensor mounted at a rear side of the solar panel. The solar radiation sensor, the ambient air temperature sensor, and the PV module temperature sensor may be integrated into a sensor box. Each of the solar radiation sensor, the ambient air temperature sensor and the PV module temperature sensor are configured to transmit signals to the forward neural network 400 of the system 100. The activation function of a node defines an output of that node given for an input or set of inputs. The activation function is responsible for transforming a summed weighted input from a node into the activation of the node and defines the specific output or “activation” of the node. The activation functions are used to get the outputs from the nodes. The plurality of hidden layers 404 uses a sigmoid function as the activation function, as shown in equation (11).

The sigmoid activation function used by the hidden layers 406:

$$ϕ ( z ) = \frac{1}{1 + {e}^{- z}} , \qquad ( 11 )$$

where z is the weight and bias adjusted input.

In an example, the output layer 406 uses a linear transfer function to map the outputs, as shown in equation (12).

The linear transfer function in the output layer 406 is given as:

ƒ(x)=x. (12)

In an aspect, the NN model is trained using a large data set such that the weights and biases can be adjusted accordingly for higher prediction accuracy. In an example, the NN predictor 112 may be trained using a Bayesian Regularization (BR) algorithm as it can produce a good generalization without overfitting, even with noisy datasets. The BR algorithm is an artificial neural network (ANN) training algorithm which corrects the weight and refraction values based on a Levenberg-Marquardt optimization. Further, according to equation (13), a Maximum A Posteriori (MAP) approach is combined with the BR algorithm as the regular Bayesian approach is computationally intensive and not controllable.

BR inference with the MAP results:

$$BR M A P = \frac{1}{2 {σ}_{w}^{2}} {Σ}_{i} {w}_{i}^{2} + \frac{1}{2 {σ}_{D}^{2}} {Σ}_{c} {( {t}_{c} - {y}_{c} )}^{2} . \qquad ( 13 )$$

where wᵢ is the weight vector, σ_{w}² represents the variance of the weights, σ_{D}² is the training dataset D variance, t_{c} is the target value, and y_{c} is the output for a given training case.

The network with updated weights was then tested with independent data and the prediction accuracy was measured using a Mean Squared Error (MSE) method. The MSE is the average squared difference between outputs and targets, given in equation (14).

Error analysis of the predicted values using MSE:

$$M S E = \frac{1}{n} {\sum }_{i = 1}^{n} {( {y}_{i} - {\hat{y}}_{i} )}^{2} , \qquad ( 14 )$$

where yᵢ is the desired NN output, and ŷᵢ is the NN output.

In the present disclosure, the NN model was trained using the four input variables, as shown in FIG. 4, such as the solar irradiance from integrated radiation sensor (IntSolIrr), the hours of sensor box (OpTm), the ambient temperature in degrees Celsius (TmpAmb), and the module temperature in degrees Celsius (TmpMdul). The original data was cleaned and randomly divided into 3 datasets, 70% of the original data was presented to the network for training, 15% of the original data was used to measure network generalization, and the remaining 15% of the original data was used to provide an independent measure of the network performance after training.

Referring to FIG. 5, a schematic block diagram 500 of the NNPC 106 of the system 100 is illustrated, according to an embodiment of the present disclosure. The NNPC 106 includes the optimization algorithm 504, and the NN model 506. The optimization algorithm 504 determines the control signal that minimizes the time constant of the LPF 108 based on the output from the NN model 506 while keeping battery SoC within predetermined limits. The NN model 506 is trained to predict future smoothing performance. Particularly, the NNPC 106 of the present disclosure is designed to use the NN model 506 of the nonlinear plant model (power plant) to predict the future smoothed power over a specified time horizon. By employing the optimization algorithm 504 (Quasi-Newton (QN) predictive optimization algorithm), the NNPC 106 solves an on-line control problem to minimize the cost function J and then computes the control input u (the LPF T_{ƒ}) such that the plant output yₚ (actual firmed PV power) follows the reference yᵣ (required PV firmed power) while complying with the imposed constraints. The NNPC 106 trains the plant model 508 (e.g., a solar power plant or a wind power plant) based on the input u (T_{ƒ} values) and an output yₚ (smoothed PV power values) data collected from the actual plant (operating in real time scenario). The NNPC 106 allows a better encapsulation of the dynamics of the plant, and thus the accuracy of the network is enhanced over the time as more input/output data is collected. Finally, the NNPC 106 calculates the control input T_{ƒ} parameter that is used in generation of the control signal u to be fed into the actual plant for solar power smoothing.

In an aspect, a Levenberg-Marquardt (LM) algorithm is used to train the NN model 506. During a LM training process, the LM algorithm utilizes the generated input u and the generated target actual plant data yₚ for training the NN model 506. The LM algorithm performs the training by defining a loss function F₍ₓ₎ as given in equation (15). Also, the NN model 506 is configured with 10 hidden layers to achieve the desired performance.

$$F ( x ) = \frac{1}{2} {{Σ}_{i = 1}^{m} [ {f}_{i} ( x ) ]}^{2} , \qquad ( 15 )$$

where m is the number of instances in collected the dataset and ƒᵢ(x) is the training error between the NN plant output firmed power yₘ and the actual plant output power yₚ defined as:

ƒᵢ(x)=yₘ−yₚ. (16)

The weights of neurons used in the NN plant model 508 were adjusted for increasing accuracy during the LM training process as:

wₖ₊₁=wₖ−(Jₖ^{T}Jₖ+λₖ^{I})⁻¹·(gₖ) (17)

where λₖ is combination coefficient (always positive), I is the identity matrix, and gₖ are the elements of the gradient vector g:

$${g}_{k} = \frac{\partial F}{\partial {w}_{k}} = \frac{\partial ( \frac{1}{2} {{Σ}_{i = 1}^{m} [ {f}_{i} ( x ) ]}^{2} )}{\partial {w}_{k}} = {Σ}_{i = 1}^{m} ( \frac{\partial {f}_{i} ( x )}{\partial {w}_{k}} {f}_{i} ( x ) ) , \qquad ( 18 )$$

where ∂ƒᵢ(x)/∂wₖ is Jacobian formula used in a matrix, and is defined as the partial derivative of the error in the predicted firmed PV power value with respect to the neuron weights. Thus the relationship between the Jacobian matrix J and the gradient vector g is:

g=J·ƒ(x). (19)

In an example, the plant model 508 (e.g., a solar power plant or a wind power plant) is created once the neuron weights wₖ have been determined during the LM training process.

As shown in FIG. 5, the QN optimization algorithm 504 has two inputs, the predicted firmed PV power yₘ from the NN model 506 and the required firmed PV power yᵣ provided by the moving average (MA) filter 502. The MA filter 502 is configured remove the fluctuations of the solar power. The MA filter 502 may operate by calculating the average value of the recorded solar PV power across a sliding window. The window size of the MA filter 502 and the real photovoltaic power data may be the required inputs to a MA smoothing algorithm. The magnitude of the MA window size directly determines the extent of solar power firming. The amount of flatness may be altered by adjusting the value of the filter window size.

The QN optimization algorithm 504 solves the optimization problem and minimizes the cost function J i.e., the error between yₘ and yᵣ. The QN optimization algorithm 504 observes the sum of the square of the control u′ increment values such that the firmed output PV power from the actual plant follows the reference PV power provided by the MA filter 502. The control signals u and u′ are the T_{ƒ} values for the LPF. The cost function J is required to be minimized:

J=Σ_{j=N}_{₁}^{N}^{₂}(yᵣ(t+j)−yₘ(t+j))²+ρΣⱼ₌₁^{N}^{ᵤ}(u′(t+j−1)−u′(t+j−2))², (20)

where the first term of the equation (20) is the error between the predicted yₘ and the required yᵣ firmed photovoltaic power. The second term of the equation (20) represents the sum of square of the control increment u′ values. N₁, N₂, and Nᵤ are the horizons over which the tracking error and the control increment are evaluated. The variable ρ determines the effect of control increment on performance.

The QN optimization algorithm 504 is computationally fast and utilizes the 1-D minimization backtracking linear routine. In an example, MATLAB is used for solving the optimization problem at each step. The iteration step from the QN optimization algorithm 504 for minimizing J:

x^{k+1}=x^{k}−[H⁻¹]·g rad(x^{k}), (21)

where xₖ is the initial value of yₘ that converges to an optimal value such that the first term in J equation (20) is minimized. The next value of yₘ is determined as x^{k+1} as shown in equation (21). The convergence criteria is given by grad(x^{k}), and H⁻¹ is an inverse approximation of a Hessian matrix:

$$H = [ \begin{matrix}\frac{{\partial }^{2} f}{\partial {x}_{1}^{2}} & \frac{{\partial }^{2} f}{\partial {x}_{1} \partial {x}_{2}} & … & \frac{{\partial }^{2} f}{\partial {x}_{1} \partial {x}_{n}} \\ \frac{{\partial }^{2} f}{\partial {x}_{2} \partial {x}_{1}} & \frac{{\partial }^{2} f}{\partial {x}_{2}^{2}} & … & \frac{{\partial }^{2} f}{\partial {x}_{2} \partial {x}_{n}} \\ ⋮ & ⋮ & ⋱ & ⋮ \\ \frac{{\partial }^{2} f}{\partial {x}_{n} \partial {x}_{1}} & \frac{{\partial }^{2} f}{\partial {x}_{n} \partial {x}_{2}} & … & \frac{{\partial }^{2} f}{\partial {x}_{n}^{2}}\end{matrix} ] . \qquad ( 22 )$$

In an aspect, the QN optimization algorithm 504 employs an approximation of the inverse of H as given in equation (22) i.e., the QN optimization algorithm 504 calculates a first partial derivative of the loss function (the error between the NN output PV power and the required MA output PV power.)

The NNPC 106 is configured with the following constraints:

0<T_{ƒ}≤120 sec. (23)

The equation (23) limits the value of the time constant T_{ƒ} between 0 and 120 s.

20%≤SoC≤100%. (24)

The constraint described in equation (24) is chosen to obey the battery SoC limits. The lower SoC limit of the battery is chosen to be 20% in order to prevent the battery from deep discharging. The upper SoC limit is 100% which indicates that the battery will overcharge upon crossing the 100% limit.

0≤u(k)≤c₁;k=0,1, . . . ,Nᵤ−1. (25)

The constraint described in equation (25) keeps the smoothed PV power between zero and rated value c₁ of the solar panels.

In an aspect, the MA filter 502 provides the reference smoothed PV power signal yᵣ for the QN optimization algorithm 504 according to equation (21), and the reference smoothed PV power signal yᵣ may be modeled using equations (26) and (27).

$${Y}_{i} = \{ \begin{matrix}\frac{{Σ}_{j = 0}^{M - 1} {S}_{i + j}}{M} & , if i > 0 and i < N - ( M - 1 ) \\ 0 & , otherwise\end{matrix} . \qquad ( 26 )$$

$${Y}_{i} = \{ \begin{matrix}\frac{{Σ}_{\frac{- ( M - 1 )}{2}}^{2} {S}_{i + j}}{M} & , if i > \frac{( M - 1 )}{2} and i < N - \frac{( M + 1 )}{2} \\ 0 & , otherwise\end{matrix} . \qquad ( 27 )$$

In equations (26) and (27), N represents the total number of data points, M is an average over a certain time period for a given power series, Yᵢ is the output of the optimization algorithms, and the input of the QN optimization algorithm 504 is the fluctuating photovoltaic power represented by Sᵢ₊ⱼ, as in [A. Atif M. Khalid, Saviztky-golay filtering for solar power smoothing and ramp rate reduction based on controlled battery energy storage, IEEE Access 8 (2020) 33806-33817, incorporated herein by reference in its entirety]. Equation (27) is used for odd number of data points.

### Results and Discussion:

To investigate the performance of the system 100, a real solar PV profile was imported to MATLAB for carrying out the required simulations.

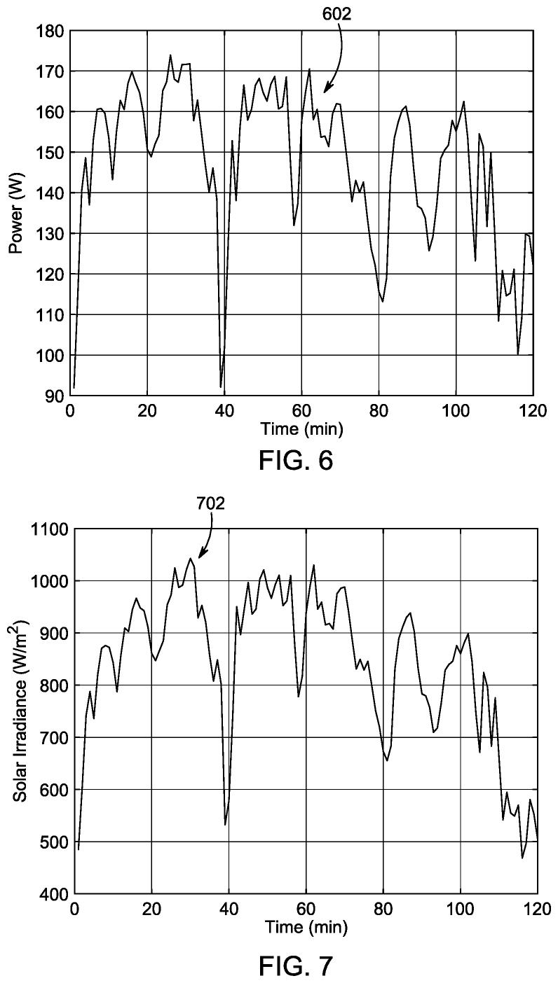

FIG. 6 is a graphical representation of recorded photovoltaic (PV) data corresponding to solar power. In FIG. 6, signal 602 indicates the PV power generated by the PV module. The PV data shown in FIG. 6 was obtained from the GECAD photovoltaic database for 20 Apr. 2013. The data was collected from solar panels with a total maximum installation capacity of 200 W. The modeled battery parameters such as the battery rated capacity (Ah), nominal voltage (V), initial battery SoC (%), and the battery response time (s) are shown in Table 1.

TABLE 1
Parameters of the BESS System.

| Parameters | Value |
|---|---|
| Battery Rated Capacity (Ah) | 2 |
| Nominal Voltage (V) | 10 |
| Initial Battery SoC (%) | 20 |
| Battery Response Time (s) | 1 |

The designed two-layer feed forward neural network 400 (as shown in FIG. 4) utilizes 4 experimentally selected input variables such as the solar irradiance from integrated radiation sensor (IntSolIrr), the hours of sensor box (OpTm), the ambient temperature (TmpAmb), and the module temperature (TmpMdul) directly influence the accuracy of the predicted solar power. FIG. 7 is a graphical representation showing solar irradiance data received from integrated radiation sensor. Signal 702 indicates the recorded solar irradiance over the time. The recorded solar irradiance (unit watt per square meter W/m²) is received from the integrated radiation sensor.

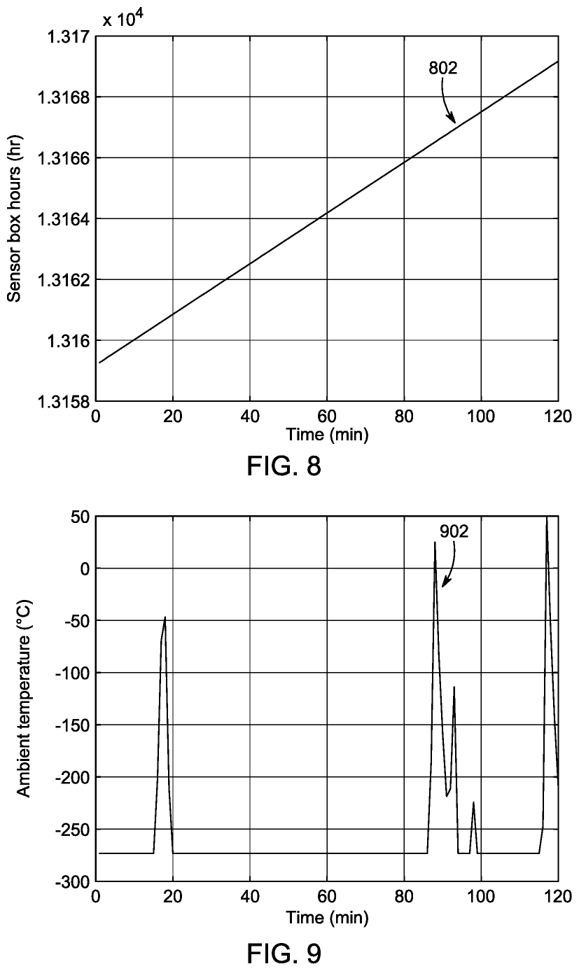

FIG. 8 is a graphical representation of sensor box hours. Signal 802 indicates the hours recorded by the sensor box for 20 Apr. 2013. The hours recorded by the sensor box is denoted by variable (OpTm).

FIG. 9 is a graphical representation of ambient temperature for 20 Apr. 2013. The ambient temperature (TmpAmb) surrounding the panel module also affects the performance of the solar panels. Signal 902 indicates the ambient temperature recorded by the ambient air temperature sensor. FIG. 9 shows the immediate surrounding temperature in degrees Celsius.

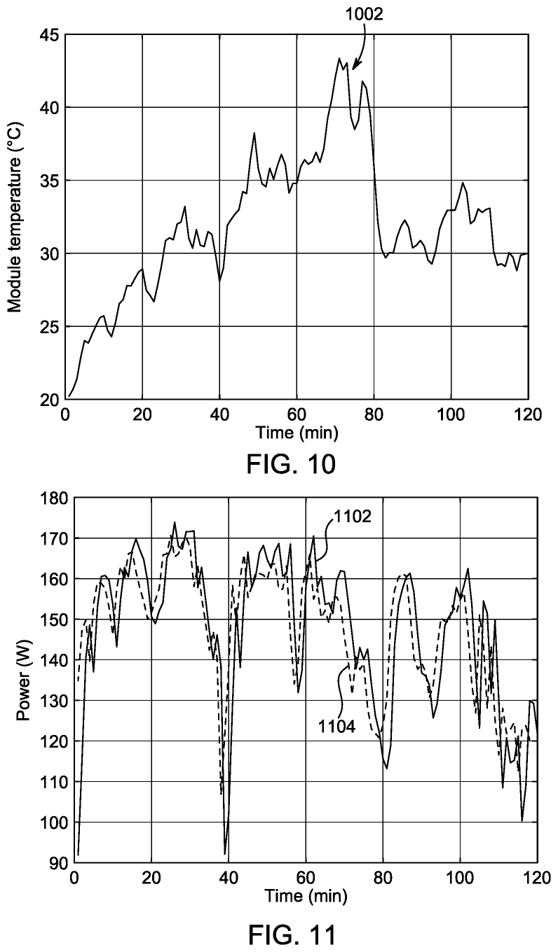

FIG. 10 is a graphical representation of PV module temperature for 20 Apr. 2013. Signal 1002 indicates the module temperature recorded by the PV module temperature sensor. The temperature of the solar panel module (TmpMdul) has a major impact on the PV power. Any fluctuations in the module temperature may directly affect the output power of the solar panel. FIG. 10 demonstrates the varying module temperature over time in degrees Celsius. Numerous experiments were performed to determine the number of hidden layers that will produce the accurate output. The optimal number of hidden layers was found to be 10.

FIG. 11 is a graphical representation of a comparison of the actual solar power with the predicted solar power for 20 Apr. 2013. Signal 1102 indicates the actual solar power. Signal 1104 indicates the predicted solar power. The performance of the NN based prediction model is demonstrated in FIG. 11. As described above, the network was trained using the BRMAP algorithm, according to the equation (13).

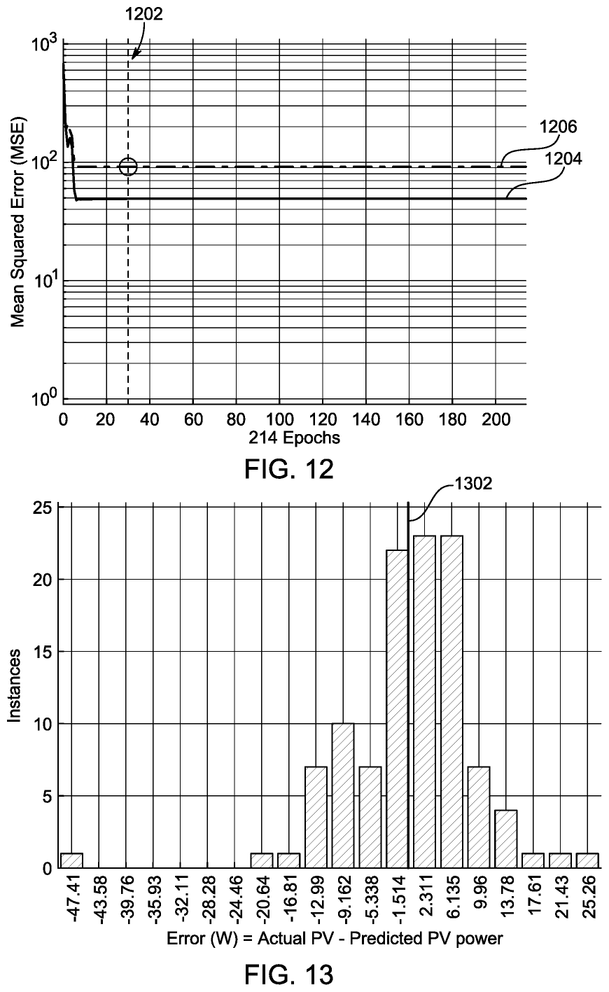

FIG. 12 illustrates a performance plot of the NN model during a training phase, and a testing phase, according to certain embodiments. Signal 1202 indicates the best case having a lowest validation error. Signal 1204 indicates the performance during the testing phase of the NN model. Signal 1206 indicates the performance during the training phase of the NN model. The performance is calculated using the mean squared error method as given in equation (14). In an example, the NN model is trained for 214 epochs. The NN model demonstrates the best training performance of 91.6664 at epoch 30 with the lowest validation error, as shown by signal 1202.

FIG. 13 illustrates an error histogram plot of the NN model with 20 bins, according to certain embodiments. Line 1302 indicates zero error. To illustrate the errors between the target (actual) PV power values and the neural network predicted PV power values, an error histogram plot is also provided in FIG. 13. It can be observed from FIG. 13 that most of the samples from the dataset has an error that falls within the range of 2.311 to 6.135.

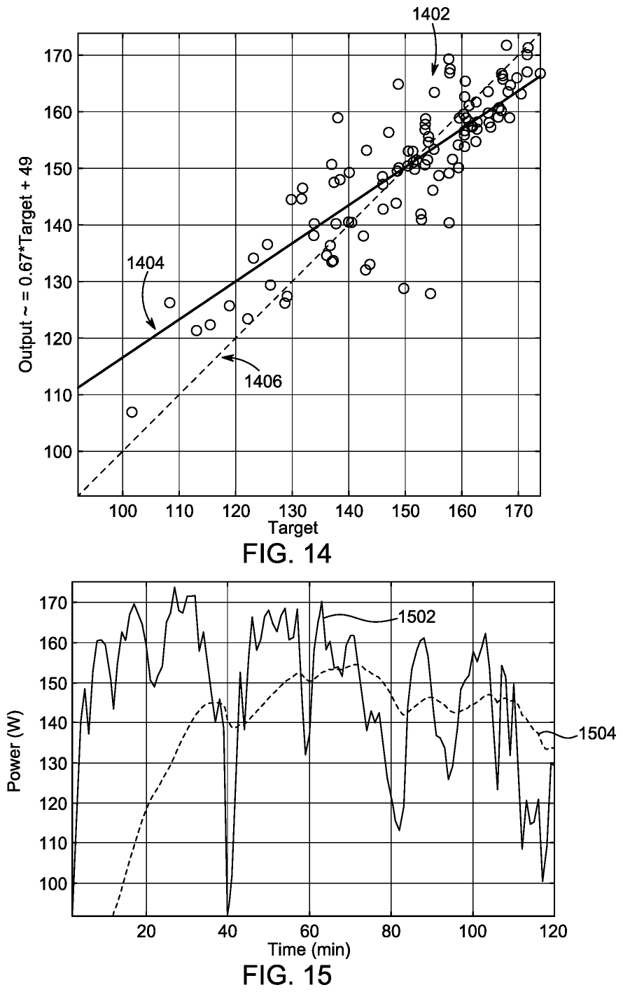

FIG. 14 illustrates a regression plot of the NN model, according to certain embodiments. Signal 1402 indicates data values. Signal 1404 indicates the fitted values. Signal 1406 indicates a condition when the output is equal to the input. The regression R plot shown in FIG. 14 measures the correlation between the outputs and targets of the NN model. As shown in FIG. 14, the R value for the training and testing phase is approximately 0.83, which indicates a close relationship between the targets and outputs.

The NNPC 106 regulates the value of the time constant T_{ƒ} so that the LPF can efficiently reduce the PV fluctuations. The constraints of equations (23), (24), and (25) are chosen or imposed so that the NNPC 106 operates under practical real-world conditions. The NN model present in the NNPC 106 models the actual plant for predicting the smoothed PV power and is trained using the Levenberg-Marquardt algorithm (equation 15), and Quasi-Newton algorithm (equation 21). Several experiments were conducted by varying the control horizon Nᵤ, cost horizons N₁, N₂, control weighing factor ρ, and the number of NN model hidden layers H to check the validity of the model. Optimal performance was achieved with N₁=1, N₂=4, Nᵤ=2, ρ=0.05, and H=10.

FIG. 15 is a graphical representation of an actual fluctuating solar power and the NNPC smoothed solar power, according to certain embodiments. As shown in FIG. 15, the NNPC 106 considerably flattens the PV abnormalities and provides a smoothed output power supply for power grid injection. It can also be recognized from FIG. 15 that the constraint as provided in equation (22) is obeyed as the smoothed power is above zero value. Signal 1502 represents the actual fluctuating solar power to be fed into the power grid. Signal 1504 represents solar power smoothed by the NNPC 106.

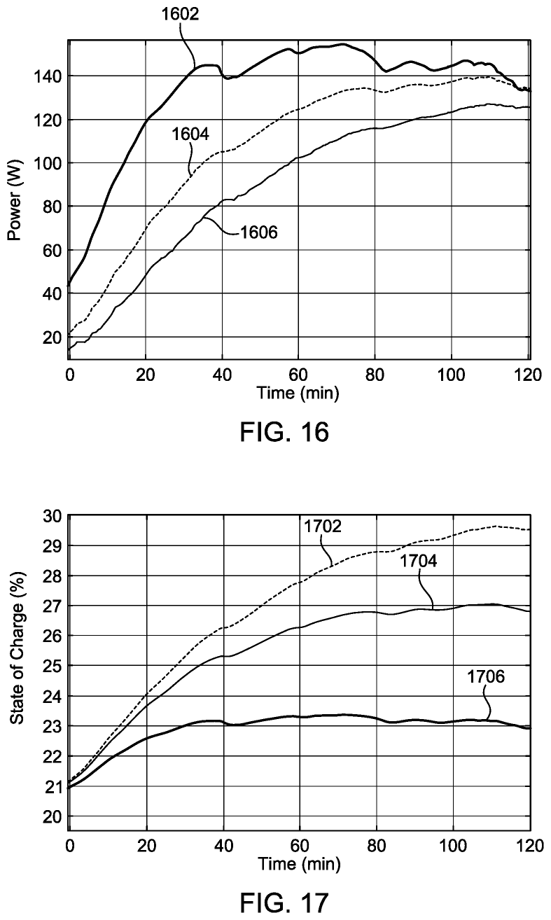

FIG. 16 is a graphical representation of time delay-based comparison between the NNPC 106 and the LPF 108), according to certain embodiments. A power smoothing comparison between the NNPC 106 and the LPF (T_{ƒ}=40 and 60) has been conducted as shown in FIG. 16. Signal 1602 represents the time delay caused by the NNPC 106. Signal 1604 represents the time delay caused by the LPF (T_{ƒ}=40). Signal 1606 represents the time delay caused by the LPF (T_{ƒ}=60). As concluded in [See: A. A. Abdalla, M. Khalid, Smoothing methodologies for photovoltaic power fluctuations, in 2019 8th International Conference on Renewable Energy Research and Applications (ICRERA), IEEE, 2019, pp. 342-346, incorporated herein by reference in its entirety] and [See: A. Atif, M. Khalid, Fuzzy logic controller for solar power smoothing based on controlled battery energy storage and varying low pass filter, IET Renew. Power Gener. 14 (18) (2020) 3824-3833, incorporated herein by reference in its entirety], it can be seen that the smoothed power as a result of the LPFs has a significant time delay. The time delay caused by the LPF is increased as the time constant T_{ƒ} increases (evident from T_{ƒ}=40 and T_{ƒ}=60). The NNPC 106 through intelligent control of the T_{ƒ} does not result in a significant time delay (as shown in FIG. 16) when compared to the regular LPFs with fixed time constants (T_{ƒ}=40 and T_{ƒ}=60). The time delay caused negatively affects the battery as it significantly increases the battery SoC and charging/discharging power [See: A. Atif, M. Khalid, Saviztky-golay filtering for solar power smoothing and ramp rate reduction based on controlled battery energy storage, IEEE Access 8 (2020) 33806-33817, incorporated herein by reference in its entirety].

FIG. 17 is a graphical representation of effect of the NNPC 106 and the LPF 108 on the battery SoC, according to certain embodiments. Signal 1702 represents an effect of the NNPC on the battery SoC. Signal 1704 represents an effect of the LPF (T_{ƒ}=40) on the battery SoC. Signal 1706 represents an effect of the LPF (T_{ƒ}=60) on the battery SoC. This is evident from FIG. 17, that the LPFs result in a higher battery SoC when compared to the NNPC 106. The SoC increases as the time constant is increased from T_{ƒ}=40 to T_{ƒ}=60. Thus, the NNPC 106 does not overcharge the battery and enhances the battery's operational life.

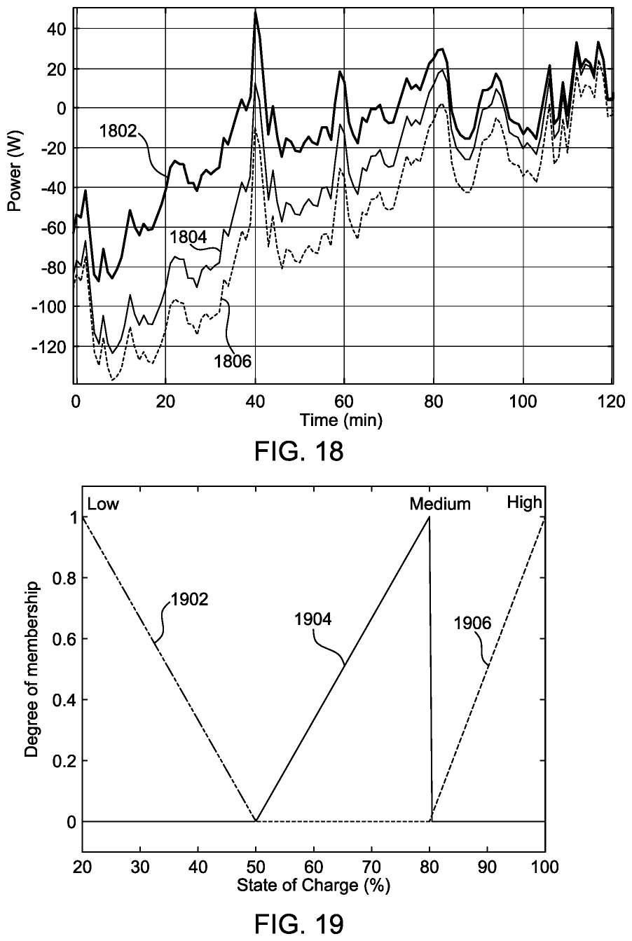

FIG. 18 is a graphical representation of effect of the NNPC 106 and the LPF 108 on the battery charging/discharging power, according to certain embodiments. Signal 1802 represents an effect of the NNPC 106 on the battery charging/discharging power. Signal 1804 represents an effect of the LPF (T_{ƒ}=40) on the battery charging/discharging power. Signal 1806 represents an effect of the LPF (T_{ƒ}=60) on the battery charging/discharging power.

For comparison purposes, a Mamdani-type Fuzzy Logic Controller (FLC) has been designed to adaptively regulate the LPF time constant T_{ƒ} to prevent the battery overcharging/deep discharging and poor SoC management. The battery SoC is the input to the FLC and T_{ƒ} is a FLC output. It has been concluded that the T_{ƒ} values directly affect the SoC as the SoC is increased with increasing T_{F} values (as shown in FIG. 17) [See: M. A. Syed, A. A. Abdalla, A. Al-Hamdi, M. Khalid, Double moving average methodology for smoothing of solar power fluctuations with battery energy storage, in: 2020 International Conference on Smart Grids and Energy Systems (SGES), IEEE, 2020, pp. 291-296, incorporated herein by reference in its entirety]. Thus, the logic of judgment rules for the FLC are: For big SoC the T_{ƒ} is small, for medium SoC the T_{ƒ} is medium, and for small SoC the T_{ƒ} is big. Like the NNPC 106, the FLC controls the SoC to secure the battery charging levels.

FIG. 19 is a graphical representation of the battery SoC fuzzy membership functions, according to certain embodiments. Signal 1902 represents a low degree membership function. Signal 1904 represents a medium degree membership function. Signal 1906 represents a high degree membership function.

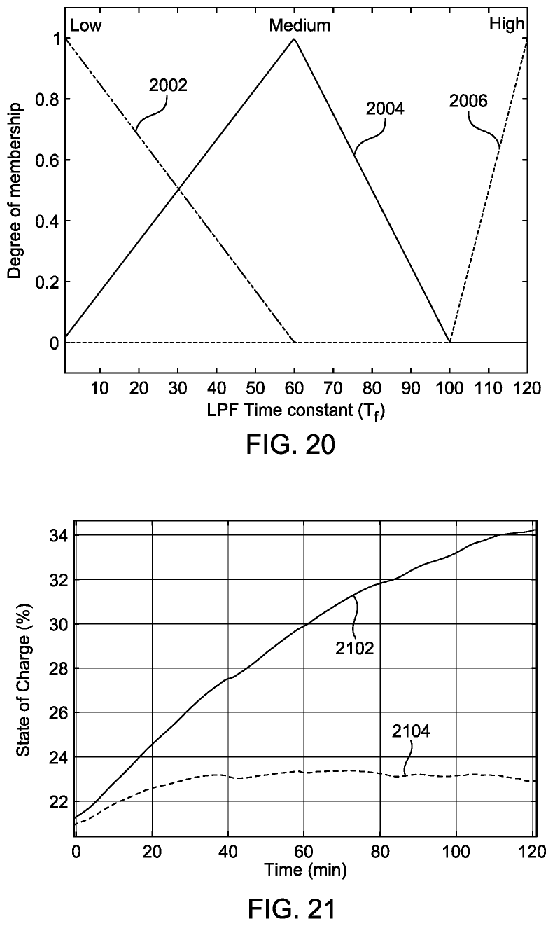

FIG. 20 is a graphical representation of LPF time constant (T_{ƒ}) fuzzy membership functions, according to certain embodiments. Signal 2002 represents a low degree LPF constant T_{ƒ} membership function. Signal 2004 represents a medium degree LPF constant T_{ƒ} membership function. Signal 2006 represents a high degree LPF constant T_{ƒ} membership function.

FIG. 21 is a graphical representation of effect of the NNPC 106 and the fuzzy logic controller (FLC) on the battery SoC, according to certain embodiments. Signal 2102 represents an effect of the FLC on the battery SoC. Signal 2104 represents an effect of the NNPC on the battery SoC. It is evident from FIG. 21 that the NNPC 106 outperforms the FLC as it manages to significantly reduce the battery SoC.

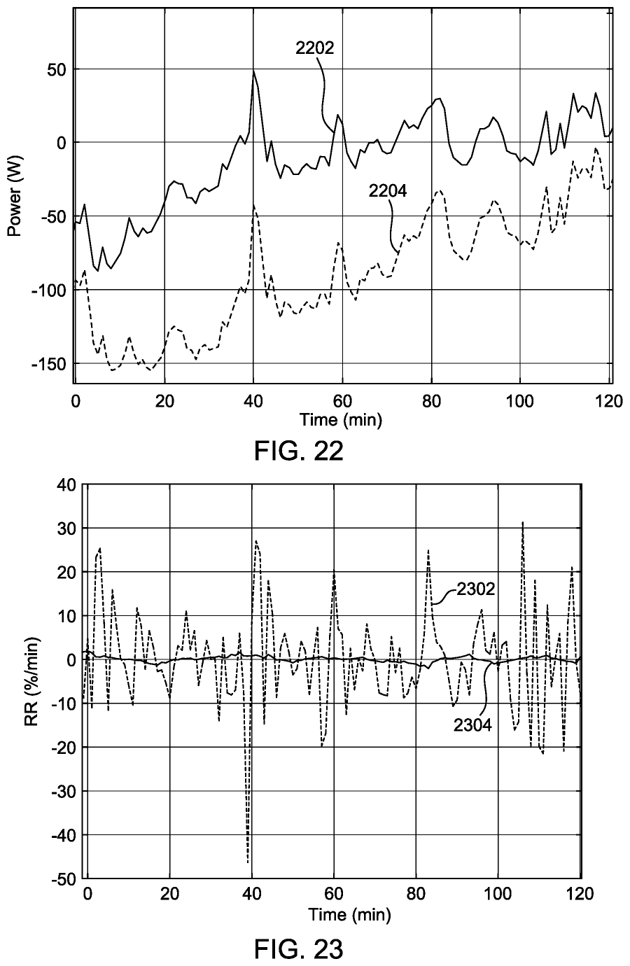

FIG. 22 is a graphical representation of effect of the NNPC 106 and the FLC on the battery charging/discharging power, according to certain embodiments. Signal 2202 represents an effect of the NNPC on the battery charging/discharging power. Signal 2204 represents an effect of the FLC on the battery charging/discharging power.

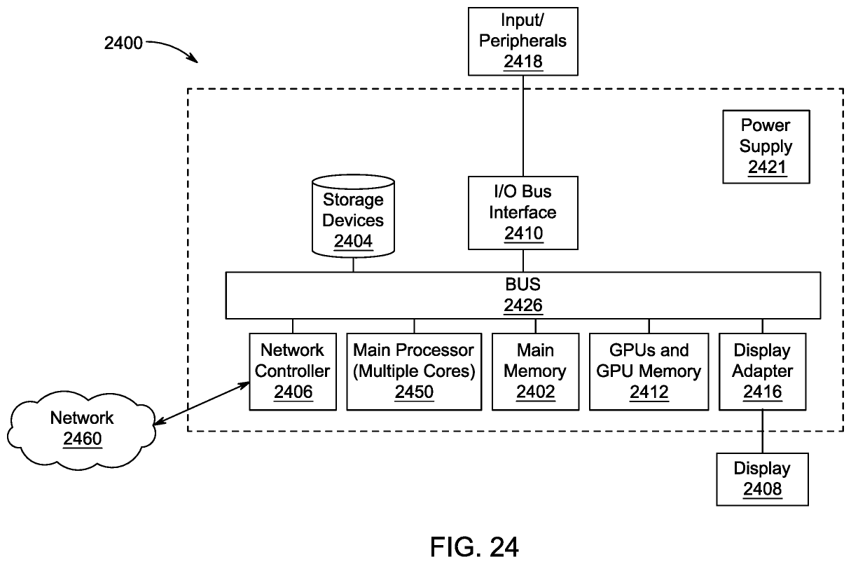

FIG. 23 is a graphical representation of solar power ramp rate comparison with the NNPC 106 and without the NNPC control, according to certain embodiments. Signal 2302 represents the solar power ramp rate without the NNPC control. Signal 2304 represents the solar power ramp rate without the NNPC control. The ramp rate of the solar power without the NNPC 106 and with the NNPC 106 is demonstrated in FIG. 23. Evidently, the NNPC 106 manages to significantly reduce the ramp rate. Thus, through the employment of the NNPC 106, successful PV power firming is achieved while enhancing the battery performance through reduced SoC and charging/discharging regulation.

According to the present disclosure, the system 100 is developed to smooth out the intermittent fluctuations of real solar power output with controlled battery energy storage. Particularly, the system 100 includes the neural network architecture for accurate PV power forecasting. In comparison to the known fuzzy logic controller, the NNPC 106 manages to significantly reduce the battery charging levels and SoC. Further, the NNPC 106 utilizes the concepts of NNs and MPC to achieve the objective of solar PV smoothing. The NNPC 106 can handle various constraints including the BESS imposed constraints and as a result it manages to maintain the optimal storage capacity of the battery while achieving the objective of PV smoothing. The NNPC 106 predicts the future power smoothing plant performance based on which the NNPC 106 regulates the control input for effective smoothing while keeping in check the imposed hard constraints. Contrasting the regular MPC that uses a mathematical model of the plant for its predictive optimization part, the NNPC 106 of the present disclosure includes the NN model of the plant. Thus, as compared to the mathematical model, the NN model better describes the dynamic nature of the plant and also resolves the problems related to mathematical complication of the MPC model that develops due to the increasing complexity in the plant. Further, the NNPC 106 has a comparatively easier approach as neural networks are proven to model highly complex systems with minimalism. Furthermore, the precision of the NN model is further increased as the collected input-output plant data increases. Simulation results were provided to demonstrate the overall effectiveness of the NNPC 106 in the prediction and smoothing of solar power, followed by its battery state of charge management and ramp rate optimization. It has been observed that the NNPC 106 considerably flattens the fluctuating solar power while improving the battery life. In comparison with the LPFs with fixed time constants (that cause a time delay in the firmed PV power), the NNPC 106 also solves the time delay issues and the negative effects it has on the battery. The NNPC 106 also outperforms the popularly used FLC in terms of battery SoC and charging/discharging regulation. Moreover, the NNPC 106 of the present disclosure may be applied to intermittent sources of energy such as the wind power.

Referring to FIG. 24, a schematic block diagram of an exemplary computer system 2400 for implementing the machine learning training and inference methods is illustrated, according to an exemplary aspect of the disclosure. The computer system 2400 may be an AI workstation running an operating system, for example Ubuntu Linux OS, Windows, a version of Unix OS, or Mac OS. The computer system 2400 may include one or more central processing units (CPU) 2450 having multiple cores. The computer system 2400 may include a graphics board 2412 having multiple GPUs, each GPU having GPU memory. The graphics board 2412 may perform many of the mathematical operations of the disclosed machine learning methods. The computer system 2400 includes main memory 2402, typically random access memory RAM, which contains the software being executed by the processing cores 2450 and GPUs 2412, as well as a non-volatile storage device 2404 for storing data and the software programs. Several interfaces for interacting with the computer system 2400 may be provided, including an I/O Bus Interface 2410, Input/Peripherals 2418 such as a keyboard, touch pad, mouse, Display Adapter 2416 and one or more Displays 2408, and a Network Controller 2406 to enable wired or wireless communication through a network 2460. The interfaces, memory and processors may communicate over the system bus 2426. The computer system 2400 includes a power supply 2421, which may be a redundant power supply.

In some embodiments, the computer system 2400 may include a CPU and a graphics card, in which the GPUs have multiple cores. In some embodiments, the computer system 2400 may include a machine learning engine.

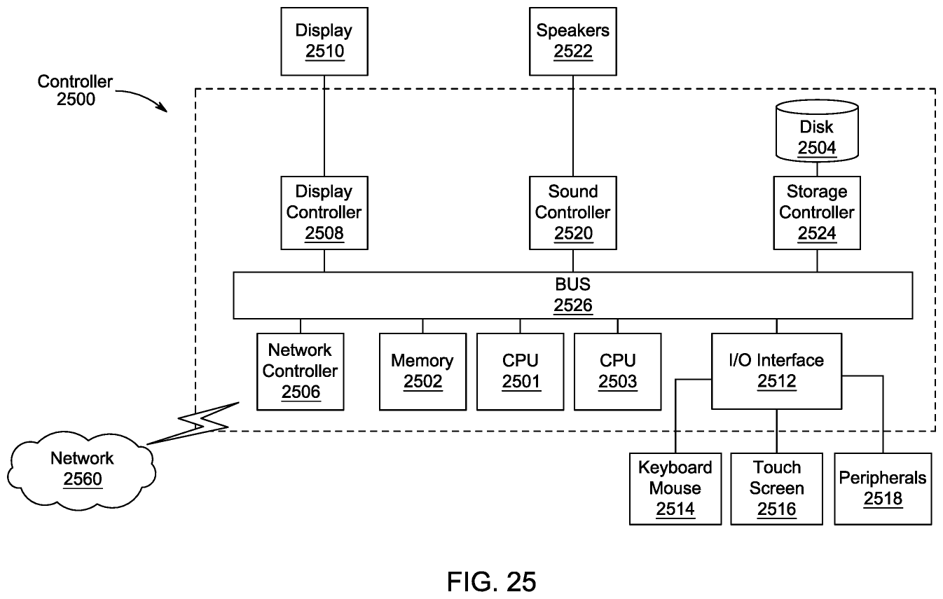

Further details of the hardware description of the computing environment of FIG. 1 according to exemplary embodiments is described with reference to FIG. 25. In FIG. 25, a controller 2500 is described is representative of the NNPC 106 and the NN predictor 112 of the system 100 of FIG. 1 in which the controller 2500 includes a CPU 2501 which performs the processes described above/below. The process data and instructions may be stored in memory 2502. These processes and instructions may also be stored on a storage medium disk 2504 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 2501, 2503 and an operating system such as Microsoft Windows 7, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 2501 or CPU 2503 may be a Xenon or Core processor from Intel of America or an Opteron processor from AMD of America, or may be other processor types that would be recognized by one of ordinary skill in the art. Alternatively, the CPU 2501, 2503 may be implemented on an FPGA, ASIC, PLD or using discrete logic circuits, as one of ordinary skill in the art would recognize. Further, CPU 2501, 2503 may be implemented as multiple processors cooperatively working in parallel to perform the instructions of the inventive processes described above.

The computing device in FIG. 25 also includes a network controller 2506, such as an Intel Ethernet PRO network interface card from Intel Corporation of America, for interfacing with network 2560. As can be appreciated, the network 2560 can be a public network, such as the Internet, or a private network such as an LAN or WAN network, or any combination thereof and can also include PSTN or ISDN sub-networks. The network 2560 can also be wired, such as an Ethernet network, or can be wireless such as a cellular network including EDGE, 3G and 4G wireless cellular systems. The wireless network can also be WiFi, Bluetooth, or any other wireless form of communication that is known.

The controller 2500 further includes a display controller 2508, such as a NVIDIA GeForce GTX or Quadro graphics adaptor from NVIDIA Corporation of America for interfacing with display 2510, such as a Hewlett Packard HPL2445w LCD monitor. A general purpose I/O interface 2512 interfaces with a keyboard and/or mouse 2514 as well as a touch screen panel 2516 on or separate from display 2510. General purpose I/O interface also connects to a variety of peripherals 2518 including printers and scanners, such as an OfficeJet or DeskJet from Hewlett Packard.

A sound controller 2520 is also provided in the computing device such as Sound Blaster X-Fi Titanium from Creative, to interface with speakers/microphone 2522 thereby providing sounds and/or music.

The general purpose storage controller 2524 connects the storage medium disk 2504 with communication bus 2526, which may be an ISA, EISA, VESA, PCI, or similar, for interconnecting all of the components of the computing device. A description of the general features and functionality of the display 2510, keyboard and/or mouse 2514, as well as the display controller 2508, storage controller 2524, network controller 2506, sound controller 2520, and general purpose I/O interface 2512 is omitted herein for brevity as these features are known.

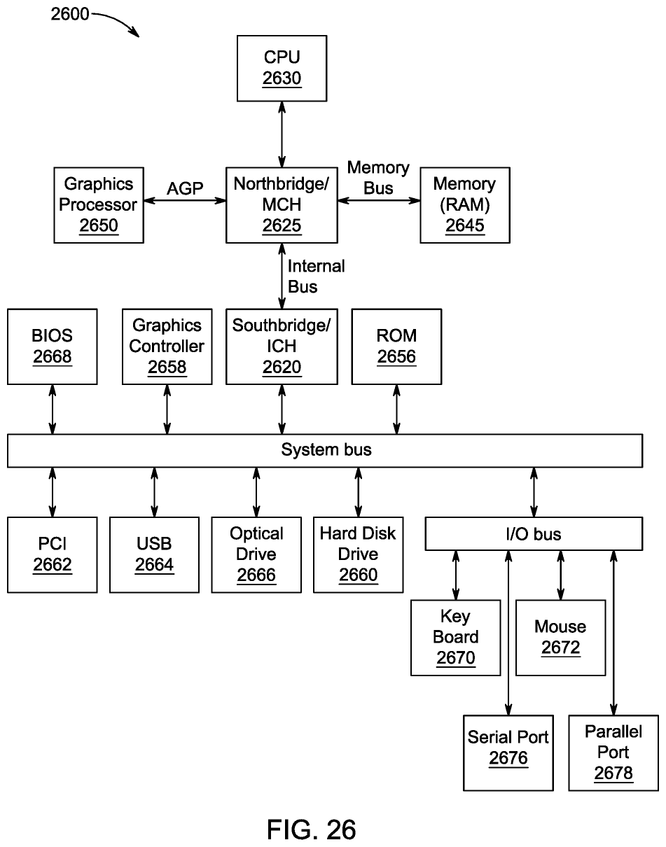

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 26.

FIG. 26 shows a schematic diagram of a data processing system, according to certain embodiments, for performing the functions of the exemplary embodiments. The data processing system is an example of a computer in which code or instructions implementing the processes of the illustrative embodiments may be located.

In FIG. 26, data processing system 2600 employs a hub architecture including a north bridge and memory controller hub (NB/MCH) 2625 and a south bridge and input/output (I/O) controller hub (SB/ICH) 2620. The central processing unit (CPU) 2630 is connected to NB/MCH 2625. The NB/MCH 2625 also connects to the memory 2645 via a memory bus, and connects to the graphics processor 2650 via an accelerated graphics port (AGP). The NB/MCH 2625 also connects to the SB/ICH 2620 via an internal bus (e.g., a unified media interface or a direct media interface). The CPU Processing unit 2630 may contain one or more processors and even may be implemented using one or more heterogeneous processor systems.

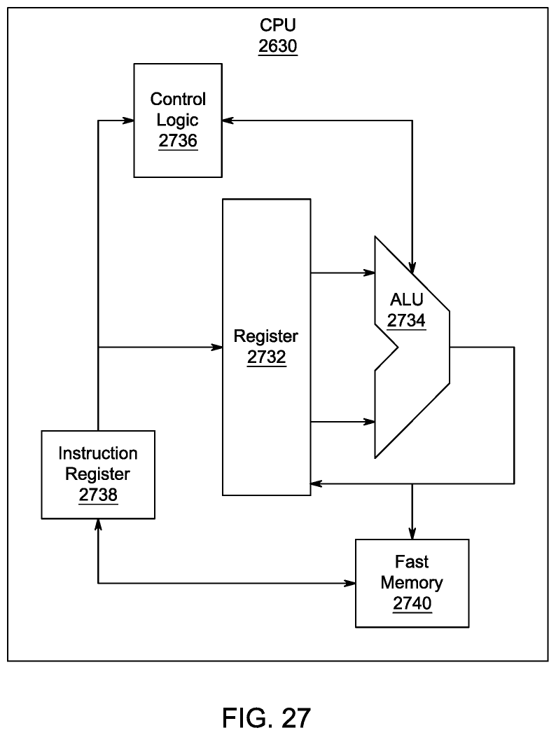

For example, FIG. 27 shows one implementation of CPU 2630. In one implementation, the instruction register 2738 retrieves instructions from the fast memory 2740. At least part of these instructions are fetched from the instruction register 2738 by the control logic 2736 and interpreted according to the instruction set architecture of the CPU 2630. Part of the instructions can also be directed to the register 2732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 2734 that loads values from the register 2732 and performs logical and mathematical operations on the loaded values according to the instructions. The results from these operations can be feedback into the register and/or stored in the fast memory 2740. According to certain implementations, the instruction set architecture of the CPU 2630 can use a reduced instruction set architecture, a complex instruction set architecture, a vector processor architecture, a very large instruction word architecture. Furthermore, the CPU 2630 can be based on the Von Neuman model or the Harvard model. The CPU 2630 can be a digital signal processor, an FPGA, an ASIC, a PLA, a PLD, or a CPLD. Further, the CPU 2630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 26, the data processing system 2600 can include that the SB/ICH 2620 is coupled through a system bus to an I/O Bus, a read only memory (ROM) 2656, universal serial bus (USB) port 2664, a flash binary input/output system (BIOS) 2668, and a graphics controller 2658. PCI/PCIe devices can also be coupled to SB/ICH 2688 through a PCI bus 2662.

The PCI devices may include, for example, Ethernet adapters, add-in cards, and PC cards for notebook computers. The Hard disk drive 2660 and CD-ROM 2666 can use, for example, an integrated drive electronics (IDE) or serial advanced technology attachment (SATA) interface. In one implementation the I/O bus can include a super I/O (SIO) device.

Further, the hard disk drive (HDD) 2660 and optical drive 2666 can also be coupled to the SB/ICH 2620 through a system bus. In one implementation, a keyboard 2670, a mouse 2672, a parallel port 2678, and a serial port 2676 can be connected to the system bus through the I/O bus. Other peripherals and devices that can be connected to the SB/ICH 2620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

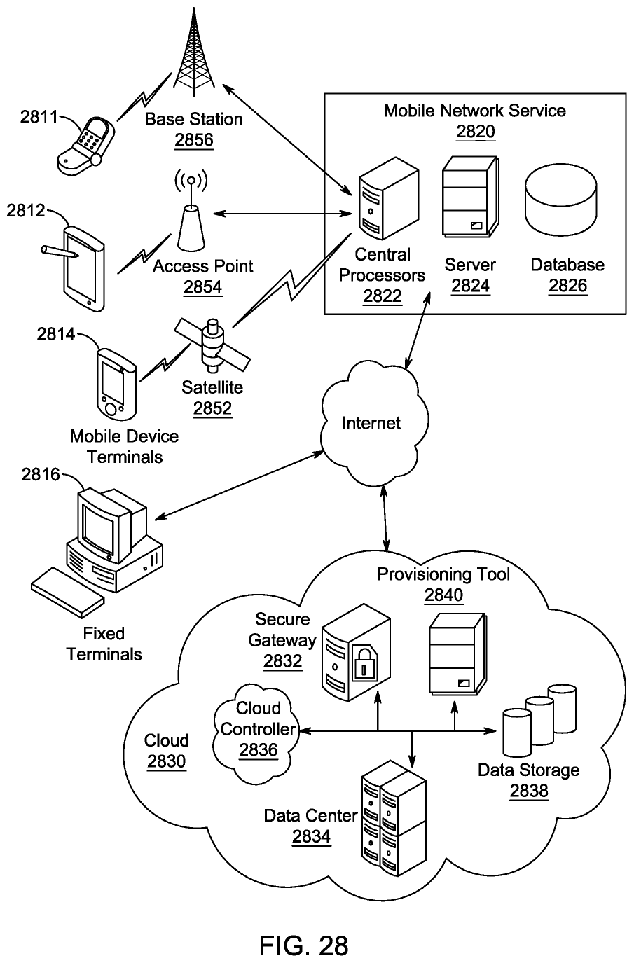

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 28, in addition to various human interface and communication devices (e.g., display monitors, smart phones, tablets, personal digital assistants (PDAs)). More specifically, FIG. 28 illustrates client devices including smart phone 2811, tablet 2812, mobile device terminal 2814 and fixed terminals 2816. These client devices may be commutatively coupled with a mobile network service 2820 via base station 2856, access point 2854, satellite 2852 or via an internet connection. Mobile network service 2820 may comprise central processors 2822, server 2824 and database 2826. Fixed terminals 2816 and mobile network service 2820 may be commutatively coupled via an internet connection to functions in cloud 2830 that may comprise security gateway 2832, data center 2834, cloud controller 2836, data storage 2838 and provisioning tool 2840. The network may be a private network, such as a LAN or WAN, or may be a public network, such as the Internet. Input to the system may be received via direct user input and received remotely either in real-time or as a batch process. Additionally, some aspects of the present disclosures may be performed on modules or hardware not identical to those described. Accordingly, other aspects of the present disclosures are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An intermittent power system to provide smoothed electric power into a power grid, comprising:
an intermittent power source;
a neural network-based predictive controller (NNPC) and a low pass filter (LPF) connected to the power grid to provide the smoothed electric power;
a neural network predictor connected between the intermittent power source and the NNPC, the neural network predictor configured to take electric power from the intermittent power source as an input and provide a predicted unsmoothed electric power,
wherein the LPF provides a smoothed PV power reference for the NNPC; and
a power grid connection to provide the smoothed electric power of the NNPC into the power grid.

2. The system of claim 1, further comprising:
a battery energy storage system (BESS) connected to the NNPC, wherein the electric power to the power grid is a combination of battery power and the smoothed electric power.

3. The system of claim 2, wherein
the NNPC maintains a storage capacity of the battery energy storage system while smoothing the electric power subject to power fluctuations.

4. The system of claim 1, wherein
the NNPC includes an optimization algorithm and a neural network model;
the optimization algorithm determines a control signal that minimizes a time constant of the LPF based on an output from the neural network model while keeping battery State of Charge (SoC) within predetermined limits; and
the neural network model is trained on a model of an intermittent power plant to predict future smoothing performance.

5. The system of claim 4, further comprising:
a moving average filter to generate a reference smoothed power signal to the optimization algorithm.

6. The system of claim 1, wherein the neural network predictor is a feed forward network having a hidden layer and an input that includes solar irradiance from integrated radiation sensor, hours of a sensor box, ambient temperature, and module temperature, and
wherein the feed forward network predicts future unsmoothed power.

7. The system of claim 1, wherein the intermittent power system is a solar photovoltaic (PV) system, and the intermittent power source is a photovoltaic (PV) power source.

8. The system of claim 1, wherein the intermittent power system is a wind power system, and the intermittent power source is a wind turbine.

9. A method of providing smoothed electric power from an intermittent power source into a power grid with a power system having a neural network-based predictive controller (NNPC), comprising:
receiving electric power from the intermittent power source and predicting unsmoothed electric power by a neural network predictor connected between the intermittent power source and the NNPC;
producing a smoothed PV power reference for the NNPC by a low pass filter (LPF) wherein the LPF provides a smoothed PV power reference for the NNPC;
producing smoothed electric power by the NNPC; and
providing the smoothed electric power of the NNPC via a power grid connection into the power grid.

10. The method of claim 9, further comprising:
generating battery power via a battery energy storage system (BESS) connected to the NNPC,
wherein the electric power to the power grid is a combination of the battery power and the smoothed electric power.

11. The method of claim 10, further comprising:
maintaining, via the NNPC, optimal storage capacity of the battery energy storage system while smoothing the electric power subject to power fluctuations.

12. The method of claim 10, wherein
the NNPC includes an optimization algorithm and a neural network model, the method further comprising:
performing the optimization algorithm to determine a control signal that minimizes a LPF time constant based on an output from the neural network model while keeping battery State of Charge (SoC) of the BESS within predetermined limits; and
training the neural network model on a model of an intermittent power plant to predict future smoothing performance.

13. The method of claim 12, further comprising:
generating, via a moving average filter, a reference smoothed power signal to the optimization algorithm.

14. The method of claim 9, wherein the neural network predictor is a feed forward network having a hidden layer and an input, the method further comprises:
inputting to the feed forward network solar irradiance from integrated radiation sensor, hours of a sensor box, ambient temperature, and module temperature; and
predicting, via the neural network predictor, future unsmoothed power.

15. A neural network-based controller to control an intermittent power system to provide smoothed electric power into a power grid, the intermittent power system having an intermittent power source, comprising:
a neural network-based predictive controller (NNPC);
a neural network predictor connected between the intermittent power source and the NNPC, the neural network predictor takes electric power from the intermittent power source as an input and makes a prediction of unsmoothed electric power;
a LPF to provide a smoothed PV power reference for the NNPC; and
the NNPC to provide the smoothed electric power to a power grid connection and into the power grid.

16. The controller of claim 15, further comprising:
a battery energy storage system (BESS) connected to the NNPC, the electric power to the power grid is a combination of battery power from the BESS and the smoothed electric power.

17. The controller of claim 16, wherein
the NNPC maintains optimal storage capacity of the BESS while smoothing the electric power subject to power fluctuations.

18. The controller of claim 15, wherein
the NNPC includes an optimization algorithm and a neural network model;
the optimization algorithm determines a control signal that minimizes a time constant of the LPF based on an output from the neural network model while keeping battery State of Charge (SoC) within predetermined limits; and
the neural network model is trained on a model of an intermittent power plant to predict future smoothing performance.

19. The controller of claim 18, further comprising:
a moving average filter to generate a reference smoothed power signal to the optimization algorithm.

20. The controller of claim 15, wherein the neural network predictor is a feed forward network having a hidden layer and an input that includes solar irradiance from integrated radiation sensor, hours of a sensor box, ambient temperature, and module temperature, and
wherein the feed forward network predicts future unsmoothed power.
